(19) United States
(12) Patent Application Publication
(10) Pub. No.: US 2013/0159179 A1
(43) Pub. Date: Jun. 20, 2013

(54) MOBILE DEVICE FOR PROCESSING APPLICATION OF CLIENT DEVICE AND METHOD FOR PROCESSING APPLICATION OF CLIENT DEVICE USING THE SAME

(71) Applicant: Electronics and Telecommunications Research In, Daejeon (KR)

(72) Inventors: Dae Seon CHOI, Daejeon (KR); Seung-Hyun KIM, Daejeon (KR); Seok Hyun KIM, Daejeon (KR); Soo Hyung KIM, Daejeon (KR); Jong-Hyouk NOH, Daejeon (KR); Sangrae CHO, Daejeon (KR); Young Seob CHO, Daejeon (KR); Jin-Man CHO, Daejeon (KR); Seung Hun JIN, Daejeon (KR)

(73) Assignee: Electronics and Telecommunications Research Institute, Daejeon (KR)

(21) Appl. No.: 13/652,373

(22) Filed: Oct. 15, 2012

(30) Foreign Application Priority Data
Dec. 15, 2011 (KR) 10-2011-0135055

(51) Int. Cl. G06Q 20/36; G06Q 20/38

(52) U.S. Cl. 705/41

(57) ABSTRACT

A mobile device for processing an application of a client device includes an application information acquisition unit configured to, when a client device receives an image signal or an audio signal converted from an application information including one or more of electronic signature requirement, payment requirement, or user authentication requirement from a web service device and plays the received image signal or the audio signal, acquire the played image signal or the audio signal. Further, the mobile device includes an e-wallet application unit configured to convert the acquired image signal or the audio signal into the application information, execute and process one or more application of electronic signature, payment, or user authentication according to the application information, and then provide the result of processing the application to the web service device.

### CROSS-REFERENCE TO RELATED APPLICATION(S)

The present invention claims priority of Korean Patent Application No. 10-2011-0135055, filed on Dec. 15, 2011, which is incorporated herein by reference.

### FIELD OF THE INVENTION

The present invention relates to a mobile device for processing application of a client device and a method for processing the application of the client device using the mobile device.

### BACKGROUND OF THE INVENTION

When processing an application such as an authenticated certificate, a credit card or the like that requires user authentication on a client device such as a personal computer (PC) and a notebook computer, a method in which credential information such as the authenticated certificate, authentication information of a user or the credit card, or the like is stored in the client device, and then the application is processed using information stored in a browser plug-in has been widely used after installing the browser plug-in such as an Active X.

As types of client devices such as smart TV, digital signage, smart pads and the like become diversified and a user uses multiple devices at the same time, the browser plug-in needs to be installed in each client device and credential information such as the authenticated certificate, the authentication information of the user or the credit card or the like needs to be stored separately in each client device.

At this time, since the types of a web browser used in each client device and an operating system (OS) are different from each other, a web service provider who provides application by using a web browser become have a burden of developing the browser plug-in suitable for each client device and the web browser.

In addition, when credential information is reproduced or duplicatedly issued to be stored in each client device, all the credential information stored in each client device needs to be updated if the credential information is updated. For example, if the authenticated certificate is updated, all the authenticated certificates stored in an office PC, a home PC, the notebook PC, a smart TV, a smart pad and the like of the user needs to be updated.

### SUMMARY OF THE INVENTION

In view of the above, the present invention provides a. mobile device which is capable of processing an application required by a web browser running on each client device even if a web browser plug-in for processing the application is not installed in each client device and credential information is not stored in each client device.

Further, the present invention provides a method which is capable of updating the credential information using the mobile device of the user such as a smartphone without updating all the credential information stored in each client device.

Further, the present invention provides safety for various security threats.

In accordance with a first, aspect of the present invention, there is provided a mobile device for processing an application of a client device, including: an application information acquisition unit configured to acquire, when a client device receives an image signal or an audio signal converted from an application information including one or more of electronic signature requirement, payment requirement or user authentication requirement from a web service device and plays the received image signal or the audio signal, the played image signal or the audio signal; and an e-wallet application unit configured to convert the acquired image signal or the audio signal into the application information, execute and process one or more application of electronic signature, payment, or user authentication according to the application information, and then provide the result of processing the application to the web service device.

In accordance with a second aspect of the present invention, there is provided a method for processing an application of a client device. The method includes the client device receiving an image signal or an audio signal converted from application information including one or more of electronic signature requirement, payment requirement, or user authentication requirement from a web service device; the client device receiving an image signal or an audio signal converted from the application information and playing the received image signal or the audio signal; a mobile device acquiring the played image signal or the audio signal; the mobile device converting the acquired image signal or the audio signal into the application information; the mobile device executing and processing at least one application of electronic signature, payment, or user authentication according to the content of the application information; and the mobile device executing and processing the application to provide the result of processing the application to the web service device.

In accordance with the embodiment of the present invention, there is no need to install a web browser plug-in in each client device for processing the application. Consequently, a web service provider need not develop, install, and manage the web browser plug-in in each client device and web browser.

Further, there is no need to store and manage credential information in each client device, thus it is possible to ease inconvenience that the user needs to issue, update and manage the credential information, in each client device.

Further, although the client device is different, an e-wallet application installed on the same mobile device is used, so that there is provided a convenience in which the user may have the same user experiences.

### BRIEF DESCRIPTION OF THE DRAWINGS

The objects and features of the present invention will become apparent from the following description of embodiments given in conjunction with the accompanying drawings, in which:

FIG. 1 is a block diagram showing the configuration of a mobile device and a web service device for processing an application of a client device in accordance with an embodiment of the present invention;

FIG. 2 is a flow chart showing processes of processing the application of the client, device by using a mobile device in accordance with the embodiment, of the present invention;

### DETAILED DESCRIPTION OF THE EMBODIMENTS

Hereinafter, embodiments of the present invention will be described in detail with reference to the accompanying drawings which form a part hereof.

Advantages and features of the invention and methods of accomplishing the same may be understood more readily by reference to the following detailed description of embodiments and the accompanying drawings. The invention may, however, be embodied in many different forms and should not be construed as being limited to the embodiments set forth herein. Rather, these embodiments are provided so that this disclosure will be thorough and complete and will fully convey the concept of the invention to those skilled in the art, and the invention will only be defined by the appended claims.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms need, to be defined throughout the description of the present invention.

Combinations of each step in respective blocks of block diagrams and a sequence diagram attached herein may be carried out by computer program instructions. Since the computer program instructions may be loaded in processors of a general purpose computer, a special purpose computer, or other programmable data processing apparatus, the instructions, carried out by the processor of the computer or other programmable data processing apparatus, create devices for performing functions described in the respective blocks of the block diagrams or in the respective steps of the sequence diagram. Since the computer program instructions, in order to implement functions in specific manner, may be stored in a memory useable or readable by a computer aiming for a computer or other programmable data processing apparatus, the instruction stored in the memory useable or readable by a computer may produce manufacturing items including an instruction device for performing functions described in the respective blocks of the block diagrams and in the respective steps of the sequence diagram. Since the computer program instructions may be loaded in a computer or other programmable data processing apparatus, instructions, a series of processing steps of which is executed in a computer or other programmable data processing apparatus to create processes executed by a computer to operate a computer or other programmable data processing apparatus, may provide steps for executing functions described in the respective blocks of the block diagrams and the respective sequences of the sequence diagram.

Moreover, the respective blocks or the respective sequences may indicate modules, segments, or some of codes including at least one executable instruction for executing a specific logical function(s). In several alternative embodiments, is noticed that functions described in the blocks or the sequences may run out of order. For example, two successive blocks and sequences may be substantially executed simultaneously or often in reverse order according to corresponding functions.

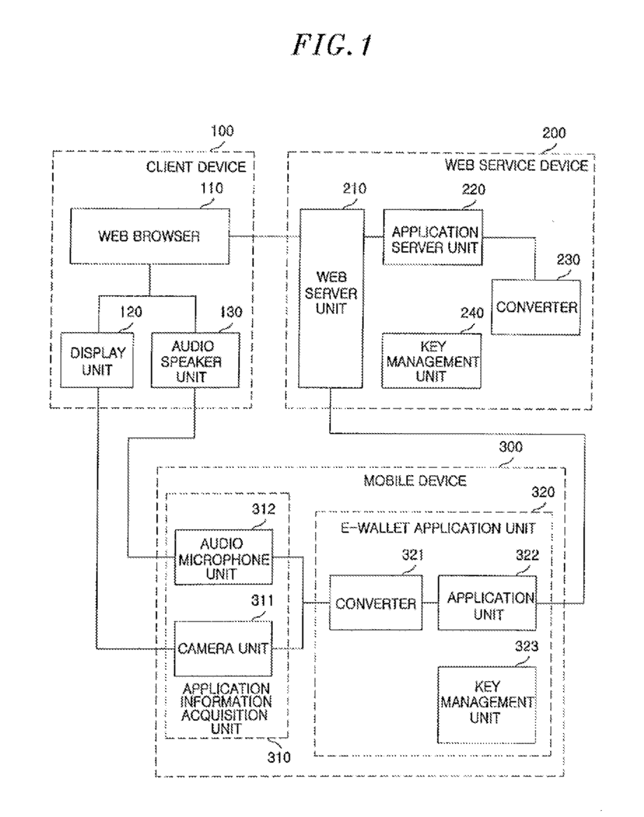

FIG. 1 is a block diagram shoving a configuration of a mobile device and a web service device for processing an application of a client device in accordance with an embodiment of the present invention.

The client device 100 means a user device such as a personal computer (PC) a notebook PC, a smart, pad, a digital signage, a smart TV or the like, which is capable of driving a web browser 110. The user uses the application such as electronic signature, payment, or user authentication using the web browser 110 in the client device 100.

This client device 100 may include display unit 120 capable of displaying the web browser 110. The web browser 110 may display, e.g., a QR code image.

In addition, the client device 100 may include an audio speaker unit 130. The audio speaker unit 130 may output audio sound modulated from digital data. At this time, the frequency band of the audio sound, which is capable of being played by the audio speaker unit 130 may be limited to the audible frequency or may additionally include an ultrasound band higher than the audible frequency band.

The web service device 200 serves as a computer device providing the application service through a web and may include a web server unit 210, an application server unit 220, a converter 230, and a key management unit 240.

The web server unit 210 may include a general web server program. The application server unit 220 may include a sever-side application program processing the application such as the electronic signature, the payment, or the user authentication. The converter 230 may convert the digital data into a QR code or the audio sound. The key management unit 240 may store and manage a cryptographic key which is available at the time of providing and receiving application processing information such as the electronic signature, the payment, or the user authentication.

The mobile device 300 may be implemented by a general smart phone, a mobile phone or the like serving as a user mobile terminal device capable of wireless data communications and may include an application information acquisition unit 310 and an e-wallet application unit 320. The application information acquisition unit 310 may include both a camera unit 311 and an audio microphone unit 312 or either of the two.

When the web browser 110 of the client device 100 receives an image signal, e.g., a QR code image and an audio sound stream, e.g., an audio signal converted from the application information including one or more of electronic signature requirement, payment requirement, or user authentication requirement from a web server device unit 200, and plays the received image signal or the audio signal, the application information acquisition unit 310 may acquire the played image signal or the audio signal.

The camera unit 311 may photograph and obtain the QR code image received by the web browser 110. The audio microphone unit 312 may receive the audio sound output from the audio speaker unit 130. The audio microphone unit. 312 may limit frequency band of the audio sound capable of being received. For example, the frequency band of the audio sound may be limited to the audible frequency or may include the ultrasound band higher than the audible frequency band.

The e-wallet application unit 320 may convert the image signal or the audio signal acquired by application information acquisition unit 310 into the application information, execute and process one or more application of the electronic signature, the payment, or the user authentication according to the application information, and then provide the result of the processing the application to the web service device unit 200.

This e-wallet application unit 320 may include a converter 321, an application unit 322 and a key management unit 323, and may be implemented by an application program. The converter 321 may convert the audio sound or the QR code image received by audio microphone unit 312 or camera unit 311 into the digital data. The application unit 322 may serve as a client in the application such as the electronic signature, the payment and the user authentication. This application unit 322 may include a function of storing credential information such as a user interface, an authenticated certificate, a credit card information and user authentication information. The key management unit 323 may store and manage an encryption key available at the time of providing and receiving the application processing information such as the electronic signature, the payment and the user authentication.

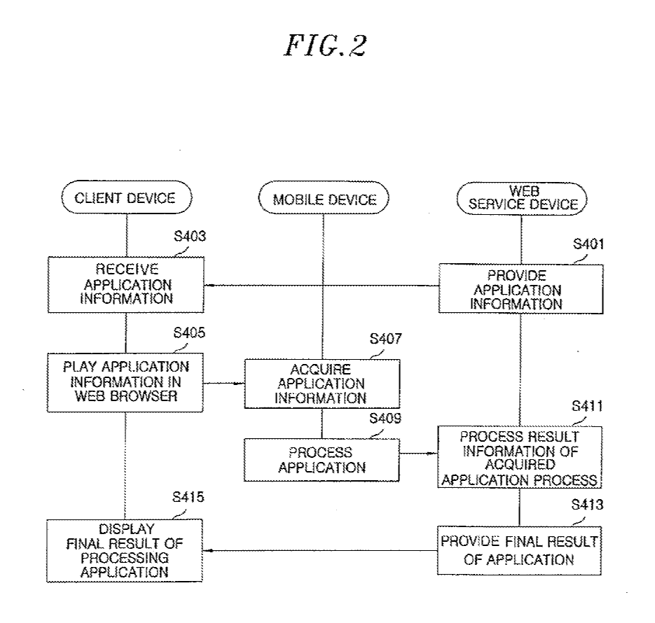

FIG. 2 is a flow chart showing processes of processing an application of a client device using a mobile device in accordance with an embodiment of the present invention.

As shown in FIG. 2, a method for processing the application of the client device includes the client device receiving the application information including one or more of electronic signature requirement, payment requirement, or user authentication requirement, from the web service device in steps S401 and S403; the client device receiving an image signal and an audio sound stream converted from the application information from a web server device unit, and playing the received image signal or the audio signal in step S405; the mobile device acquiring the played image signal or the played audio signal in step S407; the mobile device converting the acquired image signal or the audio signal into the application information, and then executing and processing one or more application of electronic signature, payment, or user authentication according to the application information to provide the result of processing the application to the web service device in step S409; the web service device processing one or more application of the electronic signature, the payment, or the user authentication according to the result, of processing the application to provide the result of the application to the client device in step S413; and the client device displaying the result of processing the application, which is received from the web service device through the web browser in step S415.

Hereinafter, the process of processing application of the client device using the mobile device in accordance with an embodiment of the present invention will be described in time series with reference to FIGS. 1 and 2.

In the initial state, the credential information such as an authenticated certificate, credit card information or user authentication information may be issued and stored in the application unit 322 of the e-wallet application unit 320 of the mobile device unit 300. Further, the information for processing the application such as the electronic signature, the payment, or the user authentication may be stored in the application server unit 220 of the web service device 200.

When a user tries to process the application such as the electronic signature, the payment, or the user authentication in the web browser 110 of the client device unit 100, the web service device 200 may create the application information including an access path (end point) of the application server unit 220, the electronic signature requirement, payment requirement, or the user authentication requirement, and convert the application information into a QR code image or an audio sound stream by the converter 230, and provide the converted QR code image or audio sound stream to the web browser 110 of the client device 100 via the web server 210 in step S401. At this time, in case of the user authentication requirement, a web session ID required to the user authentication may be included.

The web browser 110 of the client device 100 may receive the QR code image or the audio sound stream in step S403.

The web browser 110 of the client device 100 may play the received QR code image or audio sound stream. For example, the QR code image may be display on the display unit 120 and the audio sound stream may be played through the audio speaker unit 130. The user may choose one of these two output methods in step S405.

Further, the user may drive the mobile device 300 and the e-wallet application unit 320 loaded therein.

Then, the application information acquisition unit 310 of mobile device 300 may acquire the QR code image played by the web browser 110 through the camera unit 311 and the audio sound played by the audio speaker unit 130 through the audio microphone unit 310 according to the user's choice.

Then, the converter 321 of the e-wallet application unit 320 may convert the acquired QR code image or the audio sound stream into application information of the digital data, and provide the converted application information to the application unit 322.

The application unit 322 may execute the application such as the electronic signature, the payment, or the user authentication according to the content of the application information. The procedure of executing the application is to the same as that of the general application process. The result of the application process may be sent to the application server unit 220 of the web server unit 200 by using an access path of the application server unit 220 that is included in the application information. The result of the application process may include the user authentication information, electronic signature information, payment information, and the like. For example, such information may be sent to the application server unit 220 through the web server 210 in step S409.

The application server unit 220 of the web service device 200 may process the acquired result information of the application process. The process of the result information of the application process may include confirming the user authentication for a current web session through the identification of the user authentication information, verifying the electronic signature, or confirming the payment information to process the payment in step S411.

Thereafter, the application server unit 220 may provide the final result of the application to the web browser 110 of the client device 100 according to the final application process through the web server 210. The final result of the application may include a result of the user authentication, a result of verifying the electronic signature, or a result of the payment. The final result of the application may be provided through, e.g., polling using ajax and the like in the web browser 110, and may be provided through, e.g., http 200 response protocol in step S413. Finally, the web browser 110 of the client device 100 may display the final result of the application received from the web service device 200.

While the invention has been shown and described with respect to the embodiments, the present invention is not limited thereto. It will be understood by those skilled in the art that, various changes and modifications may be made without departing from the scope of the invention as defined in the following claims.

What is claimed is:

1. A mobile device for processing ah application of a client device, comprising:
an application information acquisition unit configured to acquire, when a client device receives an image signal or an audio signal converted from an application information including one or more of electronic signature requirement, payment requirement or user authentication requirement from a web service device and plays the received image signal or the audio signal, the played image signal or the audio signal; and
an e-wallet application unit configured to convert the acquired image signal or the audio signal into the application information, execute and process one or more application of electronic signature, payment, or user authentication according to the application information, and then provide the result of processing the application to the web service device.

2. The mobile device of claim 1, wherein the image signal and the audio signal include a QR code image and an audio sound stream, respectively.

3. The mobile device of claim 2, wherein the client, device plays the QR code image or the audio sound stream, and the application information acquisition unit comprises a camera unit configured to photograph the played. QR code image and an audio microphone unit configured to receive the played audio sound stream.

4. The mobile device of claim 3, wherein the e-wallet application unit comprises:
an application unit configured to store a credential information including at least, one of an authenticated certificate, credit card information and user authentication information, and execute and process the application; and
a converter configured to convert the QR code image or the audio sound stream acquired by the application information acquisition unit into the application information which is a digital data, and provide the converted application information to the application unit.

5. The mobile device of claim 1, wherein the client device receives the application information including access path information from the web service device, and the e-wallet application unit accesses the web service device according to the access path information included in the application information to provide the result of processing the application.

6. A method for processing an application of a client device, the method comprising:
the client device receiving an image signal or an audio signal converted from application information including one or more of electronic signature requirement, payment requirement, or user authentication requirement from a web service device; the client device receiving an image signal or an audio signal converted from the application information and playing the received image signal or the audio signal;
a mobile device acquiring the played image signal or the audio signal ;
the mobile device converting the acquired image signal or the audio signal into the application information;
the mobile device executing and processing at least one application of electronic signature, payment, or user authentication according to the content of the application information; and
the mobile device executing and processing the application to provide the result of processing the application to the web service device.

7. The method of claim 6, wherein the image signal and the audio signal include a QR code image and an audio sound stream, respectively.

8. The method of claim 7, wherein the client device plays the QR code image or the audio sound stream, and the mobile device photographs the played QR code image by a camera unit and receives the played audio sound stream through an audio microphone unit.

9. The method of claim 8, wherein the mobile device stores credential information including at least one of an authenticated certificate, credit card information, or user authentication information; converts the QR code image acquired by the camera unit or the audio sound stream received through the audio microphone unit into the application information that is a digital data to use the converted application information.

10. The method of claim 6, wherein the client device receives the application information including an access path information from the web service device, and accesses the web service device according to the access path information included in the application information to provide the result of processing the application.
